(19) United States
(12) Patent Application Publication
(10) Pub. No.: US 2015/0181157 A1
(43) Pub. Date: Jun. 25, 2015

(54) APPARATUS, SYSTEM AND METHOD FOR FORMATTING AUDIO-VIDEO INFORMATION

(71) Applicant: Silicon Image, Inc., Sunnyvale, CA (US)

(72) Inventors: David Kuo, Milpitas, CA (US); Jason Wong, Saratoga, CA (US); Ju Hwan Yi, Sunnyvale, CA (US); Hoon Choi, Mountain View, CA (US)

(73) Assignee: Silicon Image, Inc., Sunnyvale, CA (US)

(21) Appl. No.: 14/135,470

(22) Filed: Dec. 19, 2013

(51) Int. Cl. H04N 7/01

(52) U.S. Cl. CPC H04N 7/01

(57) ABSTRACT

Techniques and mechanisms for formatting digital audio-video (“AV”) information. In an embodiment, interface logic includes circuitry to receive digital AV information which, in one or more respects, is according to or otherwise compatible with a first interface specification. The interface logic changes a format of the digital AV information to allow for subsequent physical layer processing which is according to a second interface specification. In another embodiment, conversion logic receives analog signals according to the second interface specification and, based on such analog signals, performs digital information processing for subsequent generation of other analog signals to be transmitted according to the first interface specification.

### BACKGROUND

1. Technical Field

The present invention relates generally to the field of data communications, and more particularly, to communication of audio-video information.

2. Background Art

System-on-chip (SoC) and other integrated circuit (IC) solutions often include different stacks of processing logic for communicating various types of data. FIG. 1 show one example of a conventional application processor 100 for transmitting data. Application processor 100 includes a link layer 140 for performing digital processing of data according to a communication standard, and a physical (PHY) layer logic 130 for application processor 100 to transmit analog signals representing such data. Such analog signals can represent, for example, data other than audio data and video data. In addition, application processor 100 includes audio-video (AV) link layer logic 110 for digital processing of other, AV information according to another standard, such as an HDMI standard, for AV communications. Application processor 100 further comprises AV physical (PHY) layer logic 120 for application processor 100 to transmit analog signals representing AV information processed by AV link layer 110.

As successive generations of IC fabrication techniques continue to scale circuit speed, size and integration, there is an attendant demand for additional and more varied functionality to be incorporated into individual packages or dies. The need to meet this demand will continue to place a growing premium on IC resources such as die area and the availability of contacts (e.g. pins, pads, balls, etc.) for connecting dies and/or packages. Consequently, there is a need for new solutions to efficiently use and/or provide access to such IC resources.

### BRIEF DESCRIPTION OF THE DRAWINGS

The various embodiments of the present invention are illustrated by way of example, and not by way of limitation, in the figures of the accompanying drawings and in which:

FIG. 1 is a block diagram illustrating elements of a conventional application processor for audio-video communication.

FIG. 2 is a block diagram illustrating elements of circuit logic for performing audio-video communication according to an embodiment.

FIG. 3A is a block diagram illustrating elements of a system for exchanging audio-video information according to an embodiment.

FIG. 3B is a block diagram illustrating elements of a system for exchanging audio-video information according to an embodiment.

FIG. 4A is a flow diagram illustrating elements of a method for transmitting audio-video information according to an embodiment.

FIG. 4B is a flow diagram illustrating elements of a method for converting audio-video information according to an embodiment.

FIG. 5 is a hybrid timing and data diagram illustrating elements of audio-video data formatting performed according to an embodiment.

FIG. 6 is a data diagram illustrating elements of audio-video information formatted according to an embodiment.

FIG. 7 is a timing diagram illustrating elements of audio-video information formatted according to an embodiment.

FIG. 8 is a block diagram illustrating elements of a system for transmitting audio-video information according to an embodiment.

FIG. 9 is a block diagram illustrating elements of a system for converting audio-video information according to an embodiment.

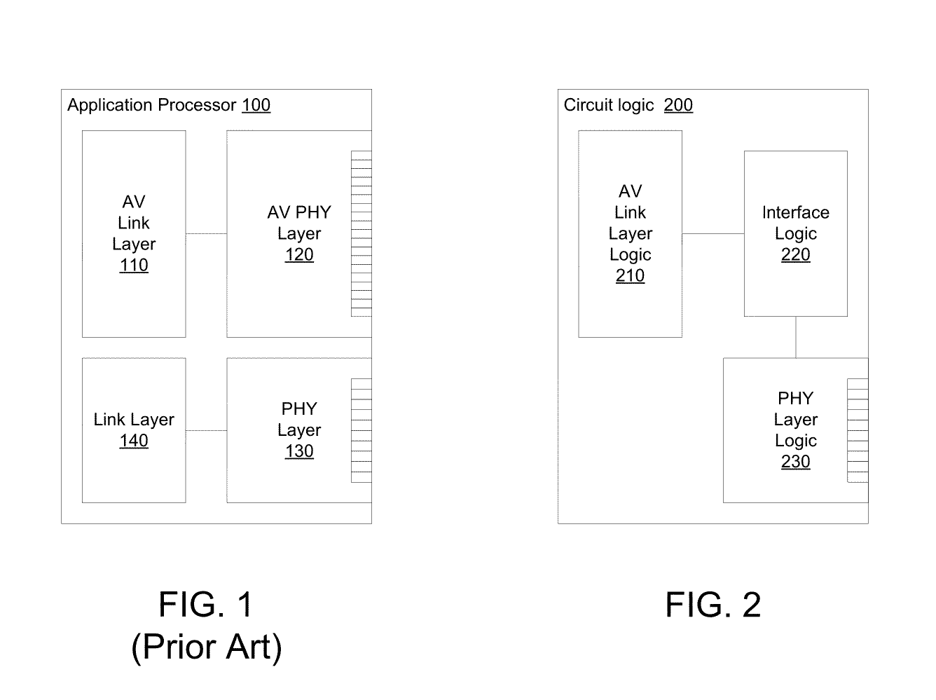

### DETAILED DESCRIPTION

Embodiments discussed herein variously provide for physical layer logic to receive digital AV information which has been processed according to a first interface specification, and to generate, according to a second interface specification, analog signals which represent that digital AV information. In some embodiments, conversion logic may receive such analog signals and convert them into second analog signals for transmission which is according to, or otherwise compatible with, the first interface specification. Such techniques and mechanisms variously facilitate the inclusion of functionality for multiple interface specifications in individual IC dies, die stacks and/or packages, while freeing such dies, die stacks and/or packages from having to have respective physical layer logic for each such interface specification.

FIG. 2 illustrates elements of circuit logic 200 for transmitting audio-video information according to an embodiment. Circuit logic 200 may provide functionality to interface link layer mechanisms and/or processes, which are compatible in one or more respects with a first interface specification, with physical layer mechanisms and/or processes which are compatible in one or more respects with a second interface specification. In an embodiment, a format for providing data in accordance with the first interface specification may not be directly compatible, according to conventional techniques, with a format for receiving data in accordance with the second interface specification.

Circuit logic 200 may include an application processor or any of various other integrated circuit hardware—e.g. residing on a single die, die stack or package—for operation as at least part of a source (and/or sink) of audio-video communications. As used herein, the term “source” refers to the characteristic of a device providing communications to some other device. Correspondingly, the term “sink” refers to the characteristic of a device receiving communications from some other (source) device. In an embodiment, circuit logic 200 includes or otherwise supports functionality of one or more conventional source devices. By way of illustration and not limitation, circuit logic 200 may support functionality including, but not limited to, that of a television, projector, cable or satellite set-top box, video player, including a DVD (Digital Versatile Disk) or Blu-Ray player, audio player, digital video recorder, smartphone, MID (Mobile Internet Device), PID (Personal Internet Device), a personal computer (e.g. tablet, notebook, laptop, desktop and/or the like), video game console, monitor, display, home theater transmitter/receiver and/or the like. Circuit logic 200 may further support of sink functionality according to techniques discussed herein and/or according to techniques of one or more conventional receiver devices.

In an embodiment, circuit logic 200 includes audio-video (AV) link layer logic 210 and interface logic 220 to receive from AV link layer logic 210 digital information including audio-video data. As used herein, the term “audio-video” refers to the characteristic of pertaining to either or both of audio information and video information. For example, AV link layer logic 210 may generate, relay or otherwise provide to interface logic 220 digital information which includes an audio data portion and/or a video data portion.

AV link layer logic 210 may include or couple to link layer circuitry which operates according to an interface specification—e.g. including, but not limited to, HDMI, MHL or any of a variety of other specifications suitable for communicating audio-video information. The interface specification may specify or otherwise reference a standard format for a unit of audio-video information, commonly referred to as a frame, for communicating video data and any audio data and/or auxiliary data associated with that video data. Some or all auxiliary data of a frame—e.g. which may include control data, clock signal and/or the like—may be metadata corresponding to the audio data and/or video data of that frame. In an embodiment, the interface specification may define a plurality of channels which are for communication of audio-video information according to the frame format. Such a plurality of channels may include, for example, transition-minimized differential signaling (TMDS) encoded channels.

In an illustrative embodiment, AV link layer logic 210 may generate, relay or otherwise provide one or more video frames each variously including respective video data, audio data and/or auxiliary data, where such data is variously associated—e.g. by state machine logic, control signaling, timing information metadata and/or the like—with respective portions of the frame format of the first interface specification. AV link layer logic 210 may perform conventional link layer processing—e.g. according to an HDMI, MHL or any of various other interface specifications—in aid of providing the digital information to interface logic. Such conventional link layer processing may include, but is not limited to, packet building, link management operations such as of a link training and status state machine (LTSSM), channel allocation, encoding such as TMDS error reduction coding (TERC) encoding, TMDS encoding and/or the like. The details of such conventional link layer processing is not limiting on certain embodiments, and is not discussed herein.

AV link layer logic 210 may perform other link layer processing in addition to such conventional link layer processing. For example, AV link layer logic 210 may provide an interface to receive digital information from other circuitry (not shown) included in or coupled to circuit logic 210, where such other circuitry provides some or all functionality of a conventional link layer. In an embodiment, AV link layer logic 210 performs decoding and/or other operations to undo some—e.g. but not all—of such conventional link layer processing.

AV link layer logic 210 may directly or indirectly indicate to interface logic 220 one or more respective characteristics for various portions of the digital information. For example AV link layer logic 210 may identify or otherwise indicate that portions of such digital information each correspond to respective portions of a frame format. For example, the frame format set forth in the first interface specification may define one or more of an active portion for the communication of video data and a blanking portion for the communication of audio data and auxiliary data associated with the video data. Such a frame format may define one or more additional or alternative portions each for a respective type of signal—e.g. including, but not limited to, a data island, a preamble, a guard band, a packet header, a control period, an encoding type and/or the like.

Based on signal timing, control signals, metadata, state machine operation and/or other resources, interface logic 220 may detect that different portions of digital information from AV link layer logic 210 each correspond to such a respective constituent portion (or portions) of the frame format. By way of illustration and not limitation, interface logic 220 may detect that certain digital information from AV link layer logic 210 is associated with a particular channel—e.g. a TMDS channel—of a plurality of channels. It is noted that the digital information in question may not necessarily be in a TMDS channel—e.g. not be TMDS encoded—when provided to interface logic 220. Additionally or alternatively, interface logic 220 may detect that certain digital information is allocated to, or otherwise associated with, part of a blanking period or of an active data period.

Interface logic 220 may format (e.g. reformat to change from a current format) some or all digital information received from AV link layer logic 210. For example, interface logic 220 may perform such formatting/reformatting based on the digital information being compatible with or otherwise corresponding to the frame format of the first interface specification. In an embodiment, interface logic 220 performs a conversion of digital information received from AV link layer logic 210 to a resulting format for receipt by physical (PHY) layer logic 230 of circuit logic 200.

Reformatting digital information may include interface logic 220 converting frames of digital information from AV link layer logic 210 each to a respective set of bytes to be provided to PHY layer logic 230. Such converting may include, for a given frame of audio-video data, allocating bits from different channels for that frame each to respective bits of a corresponding set of bytes. In an embodiment, such converting may further comprise allocating bits from one or more other control signal each to a respective bit of the same corresponding set of bytes. Such control signals may include one or more of a guard band signal, an end-of-blanking signal, a data invalid (or data enable) signal and/or the like. In one embodiment, such one or more control signals includes a skip control signal to indicate the presence of one or more placeholder bytes among the sets of bytes.

PHY layer logic 230 may provide functionality to generate an analog communication according to a second interface specification which, for example, is different from the first interface specification which includes the frame format of digital information provided by AV link layer logic 210. By way of illustration and not limitation, PHY layer logic 230 may operate in accordance with MIPI PHY standards (such as those set forth in a MIPI D-PHY specification), whereas AV link layer logic 210 may provide digital information which is compatible with a HDMI frame format or a MHL frame format. In an embodiment, PHY layer logic 230 is compatible in one or more respects with an interface specification which, for example, defines hardware, control, power mode, timing, performance and/or other requirements for providing digital-to-analog (and/or analog-to-digital) signal conversion.

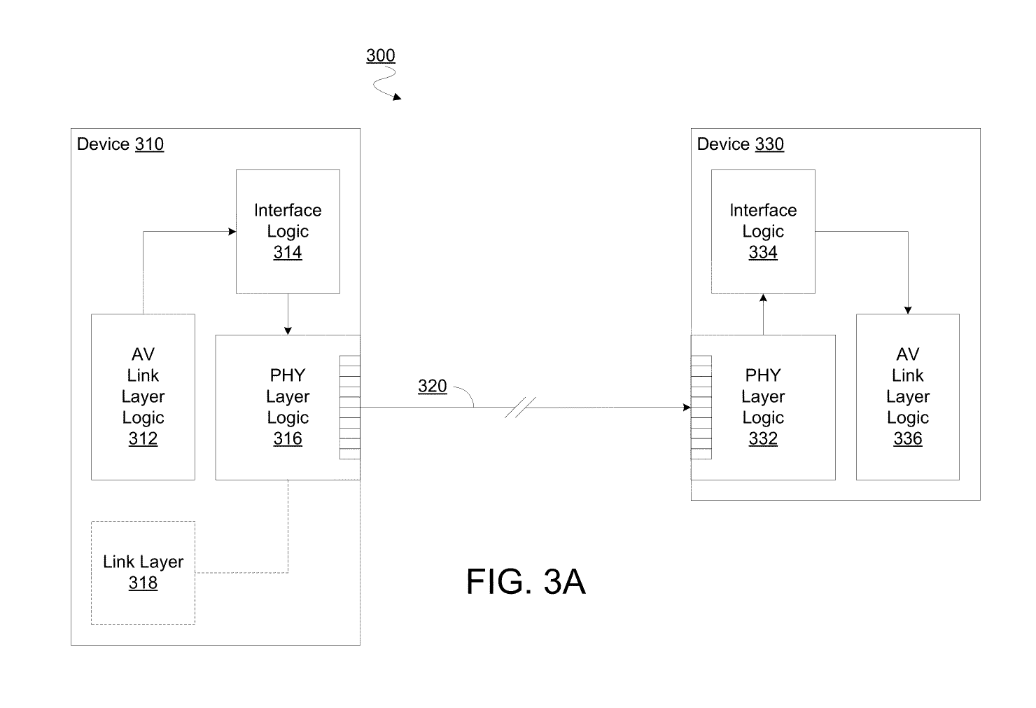

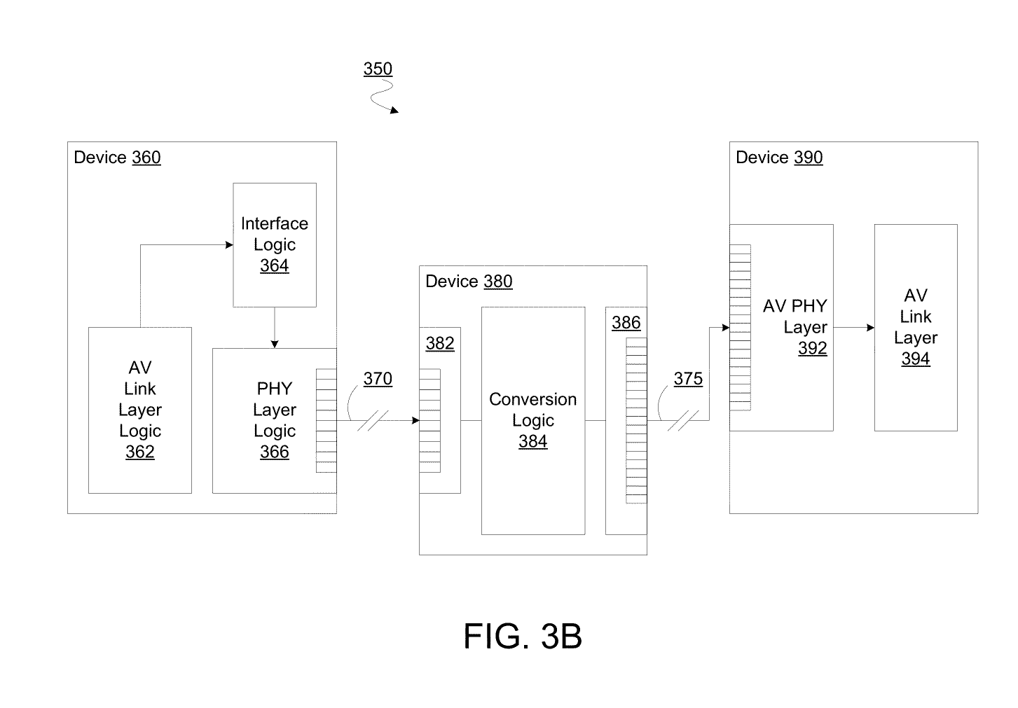

FIG. 3A illustrates elements of a system 300 for exchanging an audio-video communication according to an embodiment. Certain embodiments may, for example, be implemented within system 300 as a whole. Other embodiments may be implemented by a computer, communication and/or other electronics device of system 300, such as the illustrative device 310, for transmitting AV data. Still other embodiments may be implemented by another electronics device of system 300, such as the illustrative device 330, for receiving and processing such AV data. Certain embodiments may be implemented by circuitry—such as that of circuit logic 200—to operate as a component of an electronic device for transmitting and/or receiving such AV data.

In an embodiment, device 310 includes some or all of the features of circuit logic 200—e.g. where device 300 includes an IC die, die stack or package comprising circuit logic 200. By way of illustration and not limitation, device 310 may include AV link layer logic 312, interface logic 314 and PHY layer logic 316 which correspond functionally to AV link layer logic 210, interface logic 220 and PHY layer logic 230, respectively.

AV link layer logic 312 may generate or otherwise provide digital data which, in one or more respects, is compatible with a first interface specification for the communication of AV data. The first interface specification may, for example, be one set forth in a HDMI standard, a MHL standard, a DisplayPort (DP) standard, a Mobility DisplayPort (MyDP) standard, or the like. Interface logic 314 may (re)format some or all digital information received from AV link layer logic 312—e.g. wherein interface logic 314 converts such digital information to a format for accommodating processing by PHY layer logic 316. In an embodiment, such additional processing includes analog signal processing according to a second interface specification.

The second interface specification may include, for example, that of a MIPI D-PHY standard or any of a variety of other standards which, for example, are not for, specific to, or limited to, the communication of AV data. The second interface specification may specify a burst mode for transmitting data, and a low power mode which is distinguished from the burst mode. Alternatively or in addition, the standard may specify a total number of physical layer contacts (e.g. pins, pads or the like) which is different than a corresponding total number of physical layer contacts associated with the first interface specification for AV link layer logic 312.

Formatting of digital information from AV link layer logic 312 may include, for example, interface logic 314 variously mapping or otherwise allocating bits to respective sets of bytes to be provided to PHY layer logic 316. Such allocating may be based on interface logic 314 identifying various digital information each as being compatible with or otherwise corresponding to a respective portion of the frame format of the first interface specification. Based on the formatted digital data from interface logic 314, PHY layer logic 316 may generate analog signals for transmission via an interconnect 320 to device 330.

In an embodiment, device 330 includes circuit logic to perform signal processing which, in one or more respects, is an inverse processing with respect to that performed by device 310. For example, device 330 may include PHY layer logic 332 to receive the analog signals from device 310. PHY layer logic 332 may perform receive signal processing to generate digital data based on the received analog signals—e.g. where such generating is according to the second interface specification.

In an embodiment, interface logic 334 of device 330 may receive such digital data from PHY layer logic 332 and perform a formatting (reformatting) of the digital data to accommodate subsequent processing by AV link layer logic 336 of device 330. AV link layer logic 336 may, for example, perform receive link layer processing which is according to the first interface specification (i.e. the same interface specification according to which AV link layer logic 312 operates). In an embodiment, the formatting performed by interface logic 334 is an inverse to that performed by interface logic 334—e.g. where interface logic 334 receives sets of bytes from PHY layer logic 332 and variously orders, separates or otherwise allocates bits of such sets of bytes. Such allocation may, for example, be based on an identified association of such bits each to a respective portion of a frame format of the first interface specification.

System 300 is one example of embodiments which variously allow AV information, which has previously been and/or is subsequently to be processed according to a first interface specification, to be communicated via PHY layer logic which operates according to a second interface specification. One advantage of such embodiments is that they may variously allow other PHY layer logic to be eliminated or at least offloaded to another die, die stack, package or other IC hardware, where the other PHY layer logic operates according to the first interface specification. Another advantage is that they may allow the physical layer hardware which operates according to a second interface specification additionally or alternatively be used for otherwise conventional communications according to the second interface specification.

By way of illustration and not limitation, PHY layer logic 316 may be further coupled to other link layer logic—e.g. represented by the illustrative link layer 318—which performs conventional link layer processing according to the second interface specification. In one embodiment, a portion of PHY layer logic 316 generates analog signals based on digital data from interface logic 314, and another portion of PHY layer logic 316 exchanges other analog signals according to conventional techniques based on operation with link layer 318. Alternatively or in addition, some or all of PHY layer logic 316 may be multiplexed at different times between generating analog signals based on digital data from interface logic 314, and generating other analog signals based on digital data from link layer 318. In other embodiments, PHY layer logic 316 is not coupled for operation with any such link layer 318.

FIG. 3B illustrates elements of a system 350 for exchanging an audio-video communication according to an embodiment. System 350 includes devices 360, 380 coupled to one another via an interconnect 370, and another device 390 coupled to device 380 via an interconnect 375. Embodiments may be variously implemented, for example, by system 350 as a whole or by an electronics device such as any of devices 360, 380, 390. Certain may be implemented by circuitry—such as that of circuit logic 200—to operate as a component of an electronic device for transmitting and/or receiving such AV data.

In an embodiment, device 360 includes some or all of the features of device 310—e.g. where device 360 includes an IC die, die stack or package comprising circuit logic 200. By way of illustration and not limitation, device 360 may include AV link layer logic 362, interface logic 364 and PHY layer logic 366 which correspond functionally to AV link layer logic 312, interface logic 314 and PHY layer logic 316, respectively.

AV link layer logic 362 may provide digital data which, in one or more respects, is according to or otherwise compatible with a first interface specification, where interface logic 364 reformats such digital data to accommodate the fact that subsequent signal processing by PHY layer logic 366 is according to or otherwise compatible with a second interface specification. Based on the formatted digital data from interface logic 364, PHY layer logic 366 may generate analog signals for transmission via an interconnect 370 to device 380.

Devices 370, 380 may be or include different respective IC die—e.g. where devices 370, 380 are (or are components of) different respective IC packages. For example, devices 370, 380 may be different components of the same electronics device (not shown) of system 300, where that electronics device is distinct from and coupled to device 390. Although certain embodiments are not limited in this regard, interconnect 370 may have a total length of less than three (3) inches. For example, interconnect 370 may have a total length of less than one (1) inch. By contrast, interconnect 375 may include a connector cable for a user to manually connect to (and/or disconnect from) one or both of devices 380, 390.

Device 380 may include physical layer logic 382 to couple device 380 to interconnect 370—e.g. where physical layer logic 382 is according to or otherwise compatible with hardware requirements of the second interface specification (associated with PHY layer logic 366). Device 380 may further include physical layer logic 386 to couple device 380 to interconnect 375—e.g. where physical layer logic 386 is compatible with hardware requirements of the first interface specification (associated with AV link layer logic 362). By way of illustration and not limitation, physical layer logic 382 may be MIPI D-PHY interface, and physical layer logic 386 may be a HDMI PHY, MHL PHY, DP PHY, MyDP PHY or other such PHY interface logic for AV communications.

In an embodiment, physical layer logic 382 performs signal processing according to the second specification to generate digital data based on analog signals received from device 360 via interconnect 370. Conversion logic 384 of device 380 may reformat the digital data generated by physical layer logic 382 in preparation for processing by physical layer logic 386. Such processing may be for physical layer logic 386 to generate, according to physical layer techniques set forth in the first specification, analog signaling representing the reformatted digital data.

The reformatting by conversion logic 384 may, in one or more respects, be an inverse processing with respect to that performed by interface logic 364—e.g. where conversion logic 384 receives sets of bytes from PHY layer logic 382 and variously orders, separates or otherwise allocates bits of such sets of bytes. Such allocation may, for example, be based on an identified association of such bits each to a respective portion of a frame format of the first interface specification. In an embodiment, the digital data reformatting by conversion logic 384 may be less than all—e.g. none—of link layer processing which a conventional receiver device might otherwise perform according to the second interface specification.

Based on the reformatted digital data from conversion logic 384, PHY layer logic 386 may generate analog signals for transmission to device 390 via interconnect 375. Device 390 may include an AV PHY layer 392 to receive and process such analog signals, according to physical layer techniques set forth in, or otherwise compatible with, the first interface specification. Based on such processing, AV PHY layer 392 may generate digital data to provide to AV link layer 394 of device 390. AV link layer 394 may include circuitry to perform link layer processing which, for example, is compatible with conventional techniques of the first interface specification.

System 350 is one example of embodiments which, as compared to conventional architectures, variously offload physical layer hardware from silicon which includes associated link layer hardware—e.g. to allow improved utilization of die space, access to contacts (e.g. pins, pads, balls, etc.) and/or the like. For example, certain components of physical layer logic—such as some serializer-deserializer circuitry—may not significantly decrease in size in upcoming generations of applications processors, system-on-chip solutions or other such architectures. Offloading such physical layer logic may allow remaining architectural components to scale in size, while allowing operation with new, offloaded versions of such physical layer logic in a form factor which, overall, is smaller or otherwise more efficient.

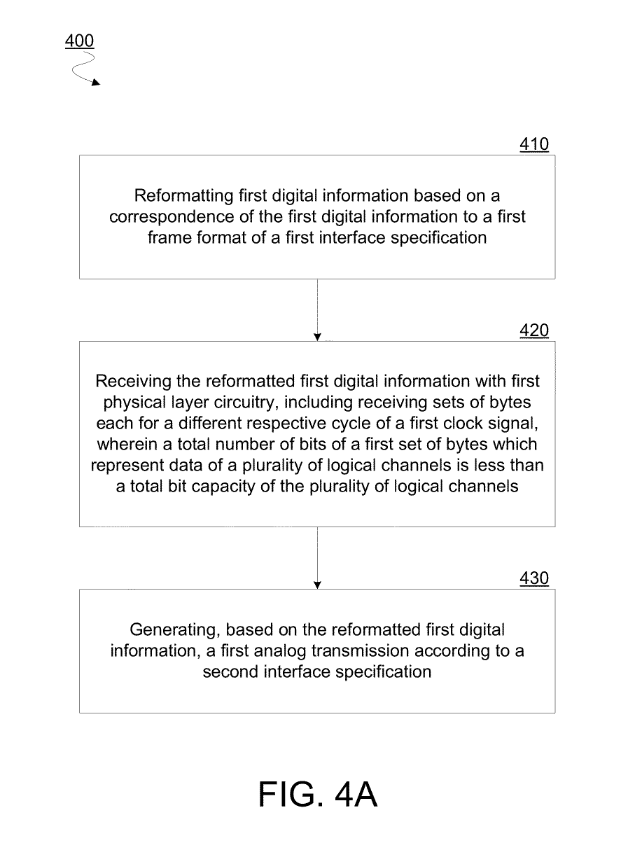

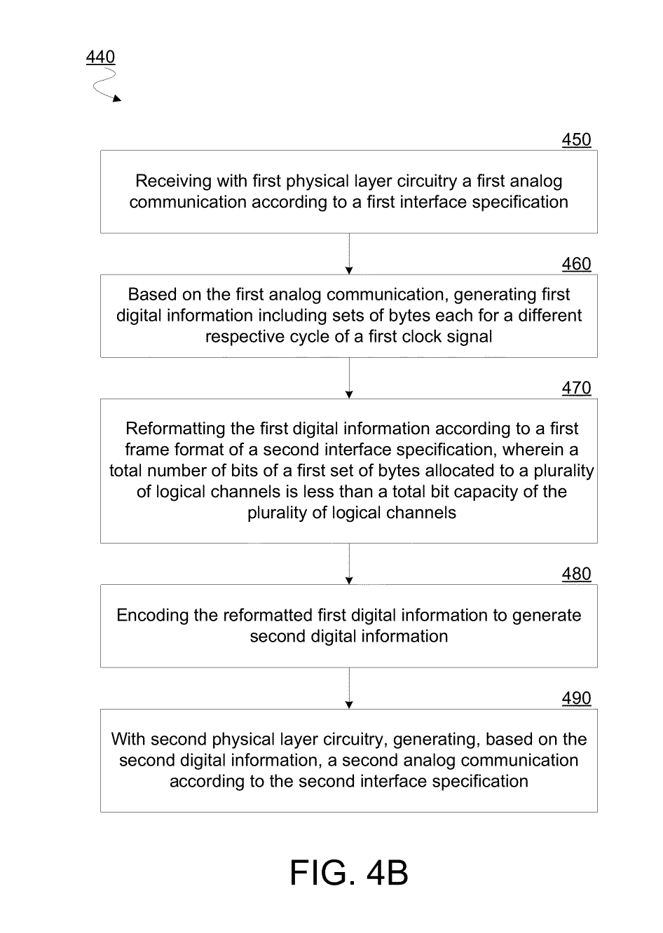

FIG. 4A illustrates elements of a method 400 for transmitting AV data according to an embodiment. Some or all of method 400 may be performed with integrated circuitry including some or all of the features of circuit logic 200. For example, method 400 may be performed by either of devices 310, 360.

Method 400 may include, at 410, reformatting first digital information based on a correspondence of the first digital information to a first frame format of a first interface specification. The reformatting at 410 may be performed, for example, by logic such as that of interface logic 220—e.g. where the first digital information is generated or otherwise provided by AV link layer logic 210. Method 400 may include one or more other operations (not shown) to generate the first digital information for reformatting at 410. For example, such one or more operations may include performing a TMDS decode operation and/or a TERC decode operation.

In an embodiment, the first frame format includes an active portion for communication of video data, and a blanking portion for communication of audio data and auxiliary data associated with the video data. Additionally or alternatively, the first interface specification may define a plurality of logical channels for communication based on the first frame format.

Method 400 may further include, at 420, receiving the reformatted first digital information with first physical layer circuitry, including the first physical layer circuitry receiving sets of bytes each for a different respective cycle of a first clock signal. As discussed herein, the sets of bytes may comprise a first set of bytes corresponding to the blanking portion of the frame format. In an embodiment, such a first set of bytes includes, for each of the plurality of logical channels, respective bits to represent data of the logical channel, wherein a total number of bits of the first set of bytes which represent data of the plurality of logical channels is less than a total bit capacity of the plurality of logical channels. In certain embodiments, the first set of bytes further comprise bits each for a respective control signal of a plurality of control signals. For example, the plurality of control signals may include a skip signal to indicate whether the first physical layer is to skip transmission of a transmission period.

In certain embodiments, the sets of bytes may further comprise a second set of bytes corresponding to the blanking portion. Such a second set of bytes may include, for each of the plurality of logical channels, respective bits to represent data of the logical channel. A total number of bits of the second set of bytes which represent data of the plurality of logical channels may be greater than the total number of bits of the first set of bytes which represent data of the plurality of logical channels. Additionally or alternatively, the sets of bytes may further comprise a third set of bytes corresponding to the active portion of the frame format. Such a third set of bytes may include, for each of the plurality of logical channels, respective bits to represent data of the logical channel. A total number of bits of the third set of bytes which represent data of the plurality of logical channels may be equal to the total bit capacity of the plurality of logical channels.

Method 400 may further comprise, at 430, generating a first analog transmission with the first physical layer circuitry, where the generating is based on the reformatted first digital information and is according to a second interface specification. Method 400 may further comprise other operations (not shown) performed by circuitry which is coupled to the circuitry performing operations 410, 420, 430. Such circuitry may, for example, include that of device 380, although certain embodiments are not limited in this regard. By way of illustration and not limitation, such additional operations may include receiving with second physical layer circuitry (e.g. PHY layer logic 382) the first analog transmission generated at 430. Based on the received first analog transmission, the second physical layer circuitry may generate second digital information including sets of bytes each for a different respective cycle of the first clock signal. The second digital information may then be reformatted according to the first frame format, and the reformatted first digital information encoded to generate third digital information. Such reformatting and encoding may be performed, for example, by circuitry providing functionality of conversion logic 384. Subsequently, second physical layer circuitry such as PHY layer logic 386 may generate, based on the third digital information, a second analog communication according to the first interface specification.

FIG. 4B illustrates elements of a method 440 for converting an AV communication according to an embodiment. Method 440 may be performed to convert an AV communication received from a device having some or all of the features of circuit logic 200. For example, method 440 may be performed with circuitry providing some or all of the functionality of device 380.

Method 440 may include, at 450, receiving with first physical layer circuitry a first analog communication according to a first interface specification. The first physical layer circuitry may, for example, include some or all circuitry of PHY layer logic 382. The first interface specification may be set forth in a MIPI-DPHY standard, although certain embodiments are not limited in this regard.

Method 440 may further comprise, at 460, generating, based on the first analog communication received at 450, first digital information which includes sets of bytes each for a different respective cycle of a first clock signal. Such first digital information may, for example, be output from PHY layer logic 382 and provided to conversion logic 384.

In an embodiment, method 440 further comprises, at 470, reformatting the first digital information according to a first frame format of a second interface specification, wherein the first frame format includes an active portion for communication of video data, and a blanking portion for communication of audio data and auxiliary data associated with the video data. As discussed herein, the first interface specification may define a plurality of logical channels for communication based on the first frame format, wherein the sets of bytes includes a first set of bytes corresponding to the blanking portion. In such an embodiment, the reformatting at 470 may include, for each logical channel of the plurality of logical channels, allocating respective bits of the first set of bytes to the logical channel, wherein a total number of bits of the first set of bytes which are allocated to the plurality of logical channels is less than a total bit capacity of the plurality of logical channels.

At 480, method 440 may include encoding the reformatted first digital information to generate second digital information. Such encoding may include, for example, performing a TMDS encode operation and/or a TERC encode operation. In an embodiment, method 440 further comprises, at 490, generating, based on the second digital information, a second analog communication according to the second interface specification. The generating at 490 may be performed, for example, with circuitry providing some or all functionality of physical layer logic 386.

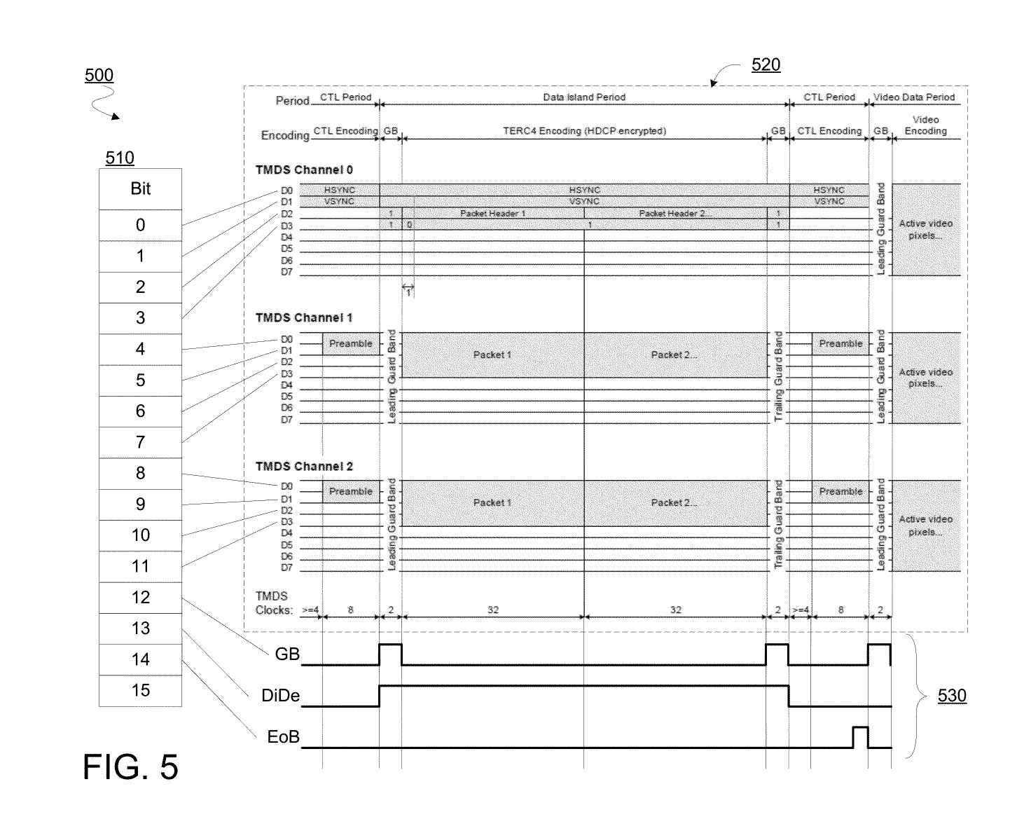

FIG. 5 shows a diagram 500 illustrating a reformatting of digital AV information according to an embodiment. The reformatting represented by diagram 500 may be performed, for example, by interface logic 220, interface logic 314, interface logic 364 or other such logic. Additionally or alternatively, an inverse (reciprocal) version of such reformatting may be performed, for example, by conversion logic 384, interface logic 334 or the like.

Diagram 500 shows a frame format 520 for AV information according to a first interface specification—in this case, a frame format set forth in an HDMI standard. Digital information to be reformatted may, in one or more respects, be received in a format according to or otherwise compatible with frame format 520. Logic to perform such reformatting may include or otherwise have access to resources—e.g. state machine logic, control signaling, timing information, metadata and/or the like—to identify various digital information each as being associated with a respective portion of frame format 520.

By way of illustration and not limitation, interface logic 220 may include or otherwise have access to mechanisms for detecting that received digital information is for a blanking period or an active data period of frame format 520. Such mechanisms may more particularly identify various digital information each as being associated with respective one of a control period, a data island period, a guard band period, and/or the like. Additionally or alternatively, such mechanisms may identify digital information as belonging to a particular logical channel of frame format 520—e.g. one of TMDS channels 0 through 2.

In an embodiment, portions of a frame format are distinguished from one another with respect to cycles of a clock—e.g. the TMDS clock cycles illustrated for frame format 520. By way of illustration and not limitation, for each of TMDS channels 0 through 2, sets of data of the channel—e.g. bytes which each comprise respective bits [D0]-[D7]—may correspond to different respective cycles of an associated TMDS clock. The TMDS (or other) clock in question may, for example, be a signal which regulates a subsequent transmission based on the reformatted digital information.

The reformatting of the digital information may be based on one or more control signals 530 which, for example, indicate how the digital information variously corresponds to respective portions of frame format 520. Such control signals 530 may include, for example, a signal GB indicating whether digital information is associated with a guard band portion of frame format 520. Alternatively or in addition, control signals 530 may include a signal DiDe indicating whether digital information is associated with a data island portion of frame format 520. Alternatively or in addition, control signals 530 may include a signal EoB indicating whether an end-of-blank point for the digital information. In an embodiment, some or all of control signals 530 are reformatted with other digital information which is according to frame format 520.

In an embodiment, formatter logic—e.g. hardware and/or executing software such as that of interface logic 220—variously allocates bits of the digital information each to a respective set of bytes. The formatter logic may thus generate multiple sets of bytes which—for example—are each for, or otherwise correspond to, a different respective cycle of a TMDS (or other) clock associated with frame format 520.

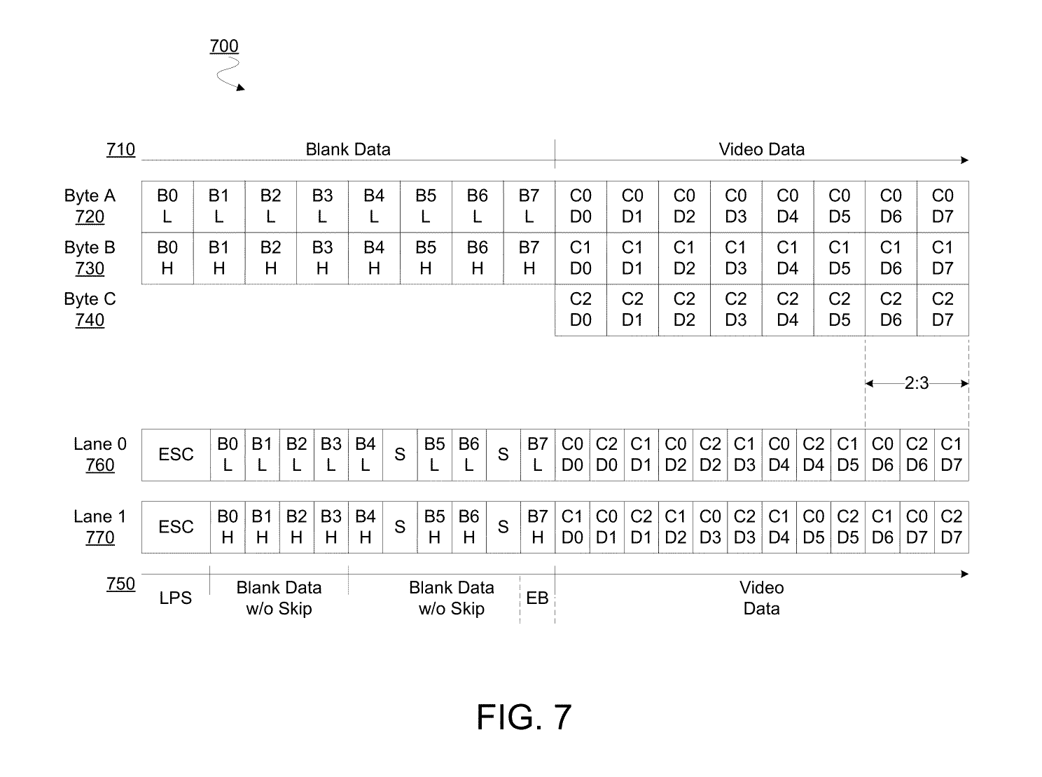

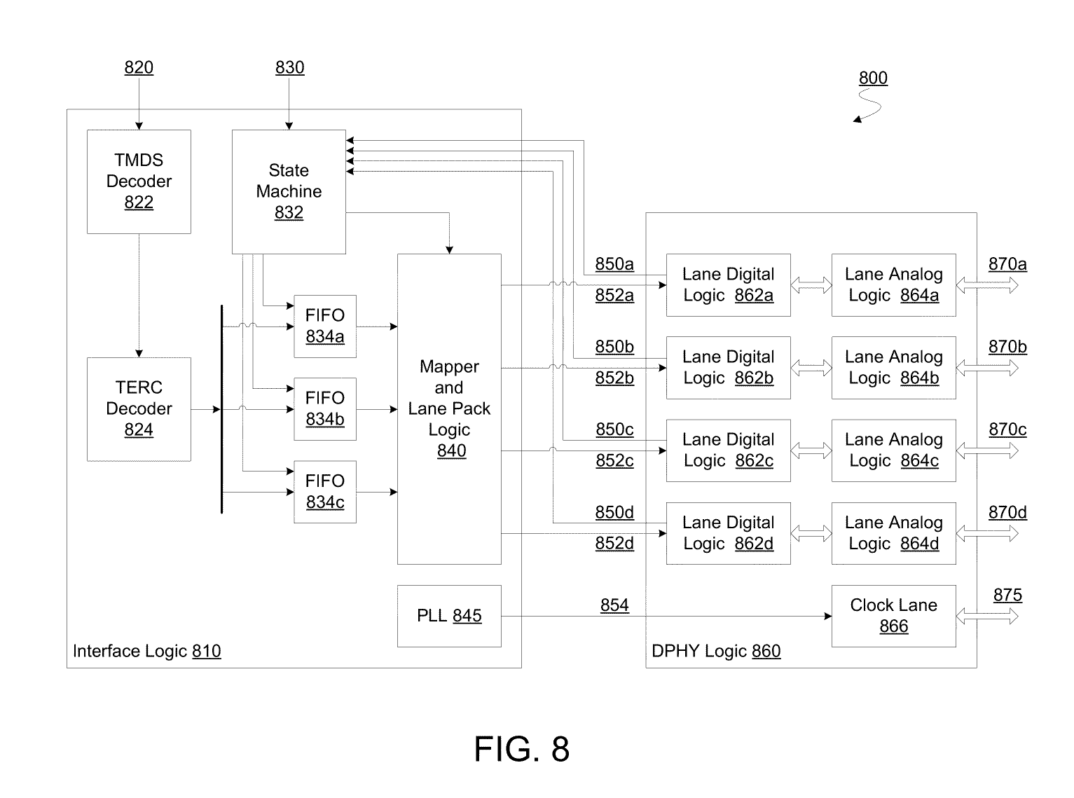

The sets of bytes may comprise a first set of bytes—represented by the illustrative bytes 510—corresponding to a clock cycle for the blanking portion of the frame format. In an embodiment, some or all of the bits 0 through 11 of bytes 510 are variously allocated from the respective bits [D0]-[D3] of TMDS channel 0 for a blanking period clock cycle, from the respective bits [D0]-[D3] of TMDS channel 1 for that same clock cycle, and from the respective bits [D0]-[D3] of TMDS channel 2 for that same clock cycle. Bits 12 through 14 of bytes 510 may be allocated, respectively, from GB, DiDe and EoB for that clock cycle. In an embodiment, a bit 15 of bytes 510 may be allocated a bit from a skip signal, which is discussed herein with respect to FIG. 7. The allocating of bits to generate bytes 510 is merely illustrative, and is not limiting on certain embodiments.

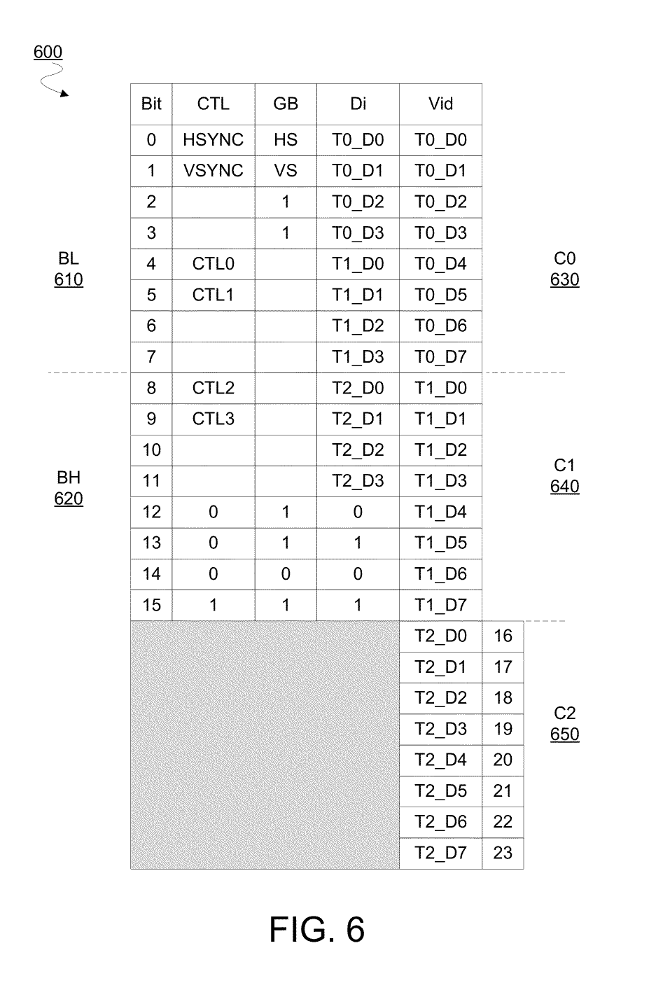

FIG. 6 shows a table 600 illustrating various sets of bits generated by reformatting of digital AV information according to an embodiment. Rows of table 600 variously represent bytes BL 610, BH 620 for respective columns CTL, GB, Di of table 600 corresponding to respective blanking period cycles of a TMDS (or other) clock. More particularly, columns CTL, GB, Di represent a control (CTL) period clock cycle, a guard band period clock cycle and a data island period clock cycle, respectively. Table 600 further represents bytes C0 630, C1 640, C2 650 for a column Vid corresponding to an active data period cycle of the clock.

In an embodiment, the allocation of digital information to generate sets of bits may vary between data for different types of clock cycles—e.g. between data for blanking period clock cycles and data for active period clock cycles. For example, the allocation of bits to bytes BL 610, BH 620 for a control period clock cycle, for a guard band clock cycle and/or for a data island clock cycle may be according to the allocation scheme shown in diagram 500.

By contrast, the allocation of bits to bytes C0 630, C1 640, C2 650 for an active data period may include mapping all bits [D0]-[D7] for each of TMDS channels 0 through 2—as represented by bits T0_D0 through T0_D7, bits T1_D0 through T1_D7 and bits T2_D0 through T2_D7. The data from one of the bytes—e.g. C2 650—may be buffered for inclusion in a sequentially earlier (or later) cycle in a resulting data sequence.

For a set of bytes generated by the formatting illustrated in FIGS. 5 and 6, a total number of bits of the set of bytes which represent data of the logical channels—e.g. TMDS channels 0 through 2—may be greater than a bit capacity of the logical channels. Alternatively or in addition, the total number of bits may be less than a corresponding total number of bits of another of the sets of bytes. For example, the bytes represented by column CTL in table 600 may include a total of six bits allocated from TMDS channels 0 through 2, whereas the bytes represented by column GB in table 600 may include a total of four bits allocated from TMDS channels 0 through 2, and the bytes represented by column Di in table 600 include a total of eight bits allocated from TMDS channels 0 through 2. By contrast TMDS channels 0 through 2 have a total bit capacity of 24 bits.

FIG. 7 shows a timing diagram 700 illustrating elements of a timing for AV data which has been reformatted according to an embodiment. Timing diagram 700 includes a sequence 710 of sets of bytes which each correspond to a respective cycle of a clock—e.g. a TMDS clock for frame format 520. The sets of bytes of sequence 710 may be generated based on bit allocation techniques such as those illustrated in table 600, although certain embodiments are not limited in this regard.

In the illustrative embodiment represented in FIG. 7, sequence 710 includes respective bytes for each of a plurality of channels—e.g. logical TMDS channels—including channel 0 720, channel 1 730 and channel 2 740. The channels 710, 720, 730 may be merely logical channels, for example, insofar as the data of sequence 710 may not currently be in actual channels of a particular type (e.g. TMDS channels). For example, data of sequence 710 may be organized according to an identified correspondence of such data to a future expected TMDS transmit channel, a previous TMDS receive channel, or the like.

Sequence 710 may include sets of bytes each corresponding to a respective clock cycle for a blanking data portion of a video frame. Alternatively or in addition, sequence 710 may include other sets of bytes each corresponding to respective clock cycles for an active data portion of the video frame. The formatting of digital data may include, for example, interface logic 220 or other such logic variously redistributing data of sequence 710 from a first grouping—e.g. a plurality of channels—according to a first interface specification to a second grouping—e.g. a plurality of lanes—according to a second interface specification. In an embodiment, a total number of groups for the first grouping is different from that of the second grouping. By way of illustration and not limitation, the sets of bytes in sequence 710 may be variously redistributed from respective ones of channels 720, 730, 740 to lanes represented in timing diagram 700 by an illustrative lane 0 760 and lane 1 770. A sequence 750 may result from such a distribution.

One or more other techniques may be further applied to implement the distribution of digital data from sequence 710 to sequence 750. For example, sequence 750 may be output at a clock rate which is quicker than that associated with sequence 710. In an embodiment, respective clocks for sequence 710 and 750 have a frequency ratio of 2:3. However, any of various other frequency ratios may be provided, according to different embodiments. Alternatively or in addition, skipped bytes—variously represented by the symbol “S” in sequence 750—may serve as placeholder (padding) portions in lanes 760, 770. Such skipped bytes may be included while interface logic 220 (or other such formatting logic) awaits incoming digital data to be variously allocated to bits of sequence 710. In an embodiment, skipped bytes will be indicated to downstream logic—e.g. interface logic 334, conversion logic 384 or the like—with a corresponding bit in a set of bytes. One example of such a bit may be the illustrative bit 15 in bytes 510, although certain embodiments are not limited in this regard.

FIG. 8 illustrates elements of a system 800 for transmitting an AV communication according to an embodiment. System 800 may include one or more integrated circuits to provide some or all of the functionality of circuit logic 200, device 310 and/or device 360, for example. In an embodiment, system 800 includes interface logic 810 to receive digital AV information which is compatible with a first interface specification, and process that digital data in preparation for subsequent physical layer processing compatible with a second interface specification. Such subsequent physical layer processing may be performed, for example, by DPHY logic 860 of system 800.

Interface logic 810 may provide some or all of the functionality of interface logic 220, interface logic 314 and/or interface logic 364, for example. In an embodiment, interface logic 810 receives digital data 820 which, in one or more respects, is according to or otherwise compatible with a frame format of an interface specification—e.g. frame format 520. Although certain embodiments are not limited in this regard, interface logic 810 may include one or both of a TMDS decoder 822 to perform TMDS decoding for digital data 820 and a TERC decoder 824 to perform TERC decoding for digital data 820. However, in an alternate embodiment, interface logic 220 may not include any such decoder logic—e.g. where digital data 820 is not TMDS encoded and/or is not TERC encoded. For example, TMDS decoder 822 and TERC decoder 824 may alternatively reside in link layer circuitry (not shown) coupled to provide digital AV data to interface logic 810. Such link layer circuitry may provide functionality of AV link layer logic 312, for example.

Interface logic 810 may comprise control logic, represented by the illustrative state machine 832, to receive control signals 830—e.g. including some or all of the control signals 530—which directly or indirectly indicate how portions of digital data 820 correspond to particular portions of the frame format. Based at least in part on control signals 830, such control logic may manage how digital data 820 (or, for example, decoded digital data output from TERC decoder 824) is to be reformatted for subsequent processing by DPHY logic 860. In an embodiment, management of the reformatting may be further based on current state of DPHY logic 860—e.g. as communicated to state machine 832 with one or more transmit ready signals 850a, 850b, 850c, 850d.

By way of illustration and not limitation, digital AV data may be variously sent to one or more buffers, represented by the illustrative FIFO buffers 834a, 834b, 834c, which may also receive various control inputs from state machine 832. Under control by state machine 832, mapper and lane pack logic 840 may selectively retrieve digital data and/or other associated auxiliary information from FIFO buffers 834a, 834b, 834c. Mapper and lane pack logic 840 may generate sets of bytes having, for example, some or all of the features of sequence 710 and redistribute such sets of bytes to generate an output such as that of sequence 750. In an embodiment, the allocation and redistribution by mapper and lane pack logic 840 results in one or more transmit data lanes 852a, 852b, 852c, 852d variously outputting respective data to DPHY logic 860.

DPHY logic 860 may provide some or all of the functionality of PHY layer logic 230, PHY layer logic 316 or PHY layer logic 366, for example. DPHY logic 860 may perform operations including conventional physical layer processing according to a second interface specification such as one set forth in a MIPI D-PHY standard. By way of illustration and not limitation, DPHY logic 860 may include lane digital logic 862a, 862b, 862c, 862d and lane analog logic 864a, 864b, 864c, 864d to perform various serialization-deserialization, digital-to-analog conversion and or other operations to process data from transmit data lanes 852a, 852b, 852c, 852d. Based on such operations, DPHY logic 860 may output analog communications 870a, 870b, 870c, 870d according to the second interface specification.

In an embodiment, the exchange of analog communications 870a, 870b, 870c, 870d may be regulated by a clock signal 875 exchanged via clock lane logic 866. Clock lane logic 866 may generate clock signal 875, for example, based on a transmit byte clock 854 provided by phase lock loop circuitry PLL 845 of interface logic 810. Alternatively or in addition, DPHY logic 860 may perform additional operations as receiver circuitry—e.g. in support of transmitting some or all of analog communications 870a, 870b, 870c, 870d. The details of such additional operations are not limiting, and are not discussed herein to avoid obscuring features of certain embodiments.

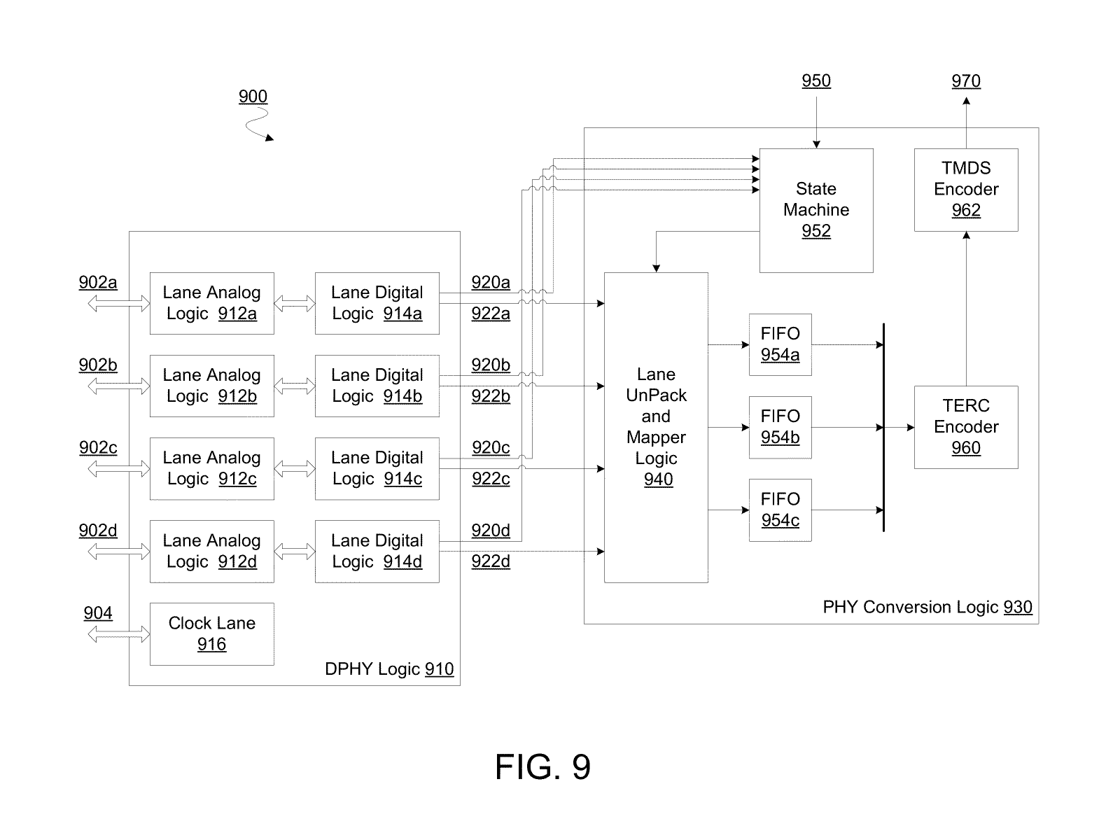

FIG. 9 illustrates elements of a system 900 for converting AV information according to an embodiment. System 900 may include one or more integrated circuits to provide some or all of the functionality of device 380, for example. In an embodiment, system 900 includes DHY logic 910 to receive analog signals which are compatible with a second interface specification, and process the analog signals in preparation for subsequent digital processing compatible with a first interface specification. Such subsequent digital processing may be performed, for example, by PHY conversion logic 930 of system 900.

DPHY logic 910 may provide some or all of the functionality of PHY layer logic 382, for example. DPHY logic 910 may perform operations including conventional physical layer processing according to an interface specification such as one set forth in a MIPI D-PHY standard. By way of illustration and not limitation, DPHY logic 910 may include lane analog logic 912a, 912b, 912c, 912d and lane digital logic 914a, 914b, 914c, 914d to perform various serialization-deserialization, analog-to-digital conversion and/or other operations to process analog communications 902a, 902b, 902c, 902d 902a, 902b, 902c, 902d. In an embodiment, the exchange of analog communications 902a, 902b, 902c, 902d may be regulated by a clock signal 904 exchanged via clock lane logic 916. Based on such analog signal processing, DPHY logic 910 may output to PHY conversion logic 930 digital data via one or more receive data lanes 922a, 922b, 922c, 922d and one or more receive active signals 920a, 920b, 920c, 920d according to the second interface specification.

PHY conversion logic 930 may provide some or all of the functionality of conversion logic 384, for example. In an embodiment, PHY conversion logic 930 comprises control logic, represented by the illustrative state machine 952, to receive signaling such as receive active signals 920a, 920b, 920c, 920d and, in an embodiment, one or more control signals 950 from PHY logic (not shown) coupled to PHY conversion logic 930. In an embodiment, one or more control signals 950 may indicate a transmit ready state for PHY circuitry such as that of PHY layer logic 386. Based at least in part on such signaling, the control logic may manage how digital data 970 is to be formatted for subsequent processing by other PHY logic (not shown) to process.

By way of illustration and not limitation, digital data from receive data lanes 922a, 922b, 922c, 922d may be provided to lane unpack and mapper logic 940 of PHY conversion logic 930. Under control by state machine 952, unpack and mapper logic 940 may selectively generate digital data and/or other associated auxiliary information to provide to one or more buffers, represented by the illustrative FIFOs 954a, 954b, 954c.

Buffered data of FIFOs 954a, 954b, 954c may variously offloaded—e.g. under control of state machine 952—to a TERC encoder 960 for TERC encoding. In an embodiment, an output of such TERC encoding may be then provided to a TMDS encoder 962 of PHY conversion logic 962 for TMDS encoding. The result of processing by lane unpack and mapper logic 940, TERC encoder 960 and TMDS encoder 962 may result in digital AV data 970 which is similar to that which may otherwise be output by conventional link layer logic according to an interface specification such one set forth in an HDMI standard, an MHL standard, a DP standard or the like. Accordingly, digital AV data 970 may be then provided to PHY layer logic (not shown) which is included in or coupled to system 900. Such PHY layer logic may process digital AV data 970, for example, to generate analog signals according to conventional techniques of that interface specification.

Techniques and architectures for exchanging audio-video communications are described herein. In the description herein, for purposes of explanation, numerous specific details are set forth in order to provide a thorough understanding of certain embodiments. It will be apparent, however, to one skilled in the art that certain embodiments can be practiced without these specific details. In other instances, structures and devices are shown in block diagram form in order to avoid obscuring the description.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description herein are presented in terms of algorithms and symbolic representations of operations on data bits within a computer memory. These algorithmic descriptions and representations are the means used by those skilled in the computing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion herein, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Certain embodiments also relate to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs) such as dynamic RAM (DRAM), EPROMs, EEPROMs, magnetic or optical cards, or any type of media suitable for storing electronic instructions, and coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description herein. In addition, certain embodiments are not described with reference to any particular programming language. It will be appreciated that a variety of programming languages may be used to implement the teachings of such embodiments as described herein.

Besides what is described herein, various modifications may be made to the disclosed embodiments and implementations thereof without departing from their scope. Therefore, the illustrations and examples herein should be construed in an illustrative, and not a restrictive sense. The scope of the invention should be measured solely by reference to the claims that follow.

What is claimed is:

1. An apparatus comprising:
interface circuit logic configured to reformat first digital information based on a correspondence of the first digital information to a first frame format of a first interface specification, wherein the first frame format includes an active portion and a blanking portion, wherein the first interface specification defines a plurality of logical channels for communication based on the first frame format; and
first physical layer circuitry coupled to receive the reformatted first digital information from the interface circuit logic, including the first physical layer circuitry to receive sets of bytes each for a different respective cycle of a first clock signal, the sets of bytes comprising a first set of bytes corresponding to the blanking portion, the first set of bytes including, for each of the plurality of logical channels, respective bits to represent data of the logical channel, wherein a total number of bits of the first set of bytes which represent data of the plurality of logical channels is less than a total bit capacity of the plurality of logical channels, wherein, based on the reformatted first digital information, the first physical layer circuitry to generate a first analog transmission according to a second interface specification.

2. The apparatus of claim 1, further comprising link layer logic to generate the first digital information.

3. The apparatus of claim 2, wherein the link layer logic to generate the first digital information includes the link layer logic to perform a transition-minimized differential signaling (TMDS) decode operation or a TMDS error reduction coding (TERC) decode operation.

4. The apparatus of claim 1, the first set of bytes further comprising bits each for a respective control signal of a plurality of control signals.

5. The apparatus of claim 4, wherein the plurality of control signals includes a skip signal to indicate whether the first physical layer is to skip transmission of data for a transmission period.

6. The apparatus of claim 1, the sets of bytes further comprising a second set of bytes corresponding to the blanking portion, the second set of bytes including, for each of the plurality of logical channels, respective bits to represent data of the logical channel, wherein a total number of bits of the second set of bytes which represent data of the plurality of logical channels is greater than the total number of bits of the first set of bytes which represent data of the plurality of logical channels.

7. The apparatus of claim 1, the sets of bytes further comprising a second set of bytes corresponding to the active portion, the second set of bytes including, for each of the plurality of logical channels, respective bits to represent data of the logical channel, wherein a total number of bits of the second set of bytes which represent data of the plurality of logical channels is equal to the total bit capacity of the plurality of logical channels.

8. The apparatus of claim 1, further comprising: a second integrated circuit configured to:
receive the first analog transmission with second physical layer circuitry;
generate, based on the received first analog transmission, second digital information including sets of bytes each for a different respective cycle of the first clock signal;
reformat the second digital information according to the first frame format;
encode the reformatted first digital information to generate third digital information;
generate, based on the third digital information, a second analog communication according to the first interface specification.

9. A method comprising: with a first integrated circuit:
reformatting first digital information based on a correspondence of the first digital information to a first frame format of a first interface specification, wherein the first frame format includes an active portion and a blanking portion, wherein the first interface specification defines a plurality of logical channels for communication based on the first frame format; and
receiving the reformatted first digital information with first physical layer circuitry, including the first physical layer circuitry receiving sets of bytes each for a different respective cycle of a first clock signal, the sets of bytes comprising a first set of bytes corresponding to the blanking portion, the first set of bytes including, for each of the plurality of logical channels, respective bits to represent data of the logical channel, wherein a total number of bits of the first set of bytes which represent data of the plurality of logical channels is less than a total bit capacity of the plurality of logical channels;
with the first physical layer circuitry, generating, based on the reformatted first digital information, a first analog transmission according to a second interface specification.

10. The method of claim 9, further comprising generating the first digital information.

11. The method of claim 10, wherein generating the first digital information includes performing a transition-minimized differential signaling (TMDS) decode operation or a TMDS error reduction coding (TERC) decode operation.

12. The method of claim 9, the first set of bytes further comprising bits each for a respective control signal of a plurality of control signals

13. The method of claim 12, wherein the plurality of control signals includes a skip signal to indicate whether the first physical layer is to skip transmission of data for a transmission period

14. The method of claim 9, the sets of bytes further comprising a second set of bytes corresponding to the blanking portion, the second set of bytes including, for each of the plurality of logical channels, respective bits to represent data of the logical channel, wherein a total number of bits of the second set of bytes which represent data of the plurality of logical channels is greater than the total number of bits of the first set of bytes which represent data of the plurality of logical channels

15. The method of claim 9, the sets of bytes further comprising a second set of bytes corresponding to the active portion, the second set of bytes including, for each of the plurality of logical channels, respective bits to represent data of the logical channel, wherein a total number of bits of the second set of bytes which represent data of the plurality of logical channels is equal to the total bit capacity of the plurality of logical channels

16. The method of claim 9, further comprising: with a second integrated circuit:
receiving the first analog transmission with second physical layer circuitry;
based on the received first analog transmission, generating second digital information including sets of bytes each for a different respective cycle of the first clock signal;
reformatting the second digital information according to the first frame format;
encoding the reformatted first digital information to generate third digital information;
with second physical layer circuitry, generating, based on the third digital information, a second analog communication according to the first interface specification.

17. An apparatus comprising:
first physical layer circuitry to receive a first analog communication according to a first interface specification and to generate, based on the received first analog communication, first digital information including sets of bytes each for a different respective cycle of a first clock signal;
conversion circuitry to reformat the first digital information according to a first frame format of a second interface specification, wherein the first frame format includes an active portion and a blanking portion, wherein the first interface specification defines a plurality of logical channels for communication based on the first frame format, wherein the sets of bytes includes a first set of bytes corresponding to the blanking portion, and wherein the conversion circuitry to reformat the first digital information includes:
for each logical channel of the plurality of logical channels, the conversion circuitry to allocate respective bits of the first set of bytes to the logical channel,
wherein a total number of bits of the first set of bytes which are allocated to the plurality of logical channels is less than a total bit capacity of the plurality of logical channels, the conversion circuitry further to encode the reformatted first digital information to generate second digital information; and
second physical layer circuitry to generate, based on the second digital information, a second analog communication according to the second interface specification.

18. The apparatus of claim 17, wherein the conversion logic to encode the reformatted first digital information includes the conversion logic to perform a transition-minimized differential signaling (TMDS) encode operation or a TMDS error reduction coding (TERC) encode operation.

19. The apparatus of claim 17, wherein the first set of bytes further comprises bits each for a respective control signal of a plurality of control signals.

20. The apparatus of claim 19, wherein the plurality of control signals includes a skip signal to indicate whether a transmission period is a skipped transmission period.

21. The apparatus of claim 17, the sets of bytes further comprising a second set of bytes corresponding to the blanking portion, the second set of bytes including, for each of the plurality of logical channels, respective bits to represent data of the logical channel, wherein a total number of bits of the second set of bytes which represent data of the plurality of logical channels is greater than the total number of bits of the first set of bytes which represent data of the plurality of logical channels.

22. The apparatus of claim 17, the sets of bytes further comprising a second set of bytes corresponding to the active portion, the second set of bytes including, for each of the plurality of logical channels, respective bits to represent data of the logical channel, wherein a total number of bits of the second set of bytes which represent data of the plurality of logical channels is equal to the total bit capacity of the plurality of logical channels.

23. A method comprising:
receiving with first physical layer circuitry a first analog communication according to a first interface specification;
based on the received first analog communication, generating first digital information including sets of bytes each for a different respective cycle of a first clock signal;
reformatting the first digital information according to a first frame format of a second interface specification, wherein the first frame format includes an active portion and a blanking portion, wherein the first interface specification defines a plurality of logical channels for communication based on the first frame format, wherein the sets of bytes includes a first set of bytes corresponding to the blanking portion, and wherein the reformatting includes:
for each logical channel of the plurality of logical channels, allocating respective bits of the first set of bytes to the logical channel, wherein a total number of bits of the first set of bytes which are allocated to the plurality of logical channels is less than a total bit capacity of the plurality of logical channels;
encoding the reformatted first digital information to generate second digital information; and
with second physical layer circuitry, generating, based on the second digital information, a second analog communication according to the second interface specification.

24. The method of claim 23, wherein encoding the reformatted first digital information includes performing a transition-minimized differential signaling (TMDS) encode operation or a TMDS error reduction coding (TERC) encode operation.

25. The method of claim 23, wherein the first set of bytes further comprises bits each for a respective control signal of a plurality of control signals.

26. The method of claim 25, wherein the plurality of control signals includes a skip signal to indicate whether a transmission period is a skipped transmission period.

27. The method of claim 23, the sets of bytes further comprising a second set of bytes corresponding to the blanking portion, the second set of bytes including, for each of the plurality of logical channels, respective bits to represent data of the logical channel, wherein a total number of bits of the second set of bytes which represent data of the plurality of logical channels is greater than the total number of bits of the first set of bytes which represent data of the plurality of logical channels.

28. The method of claim 23, the sets of bytes further comprising a second set of bytes corresponding to the active portion, the second set of bytes including, for each of the plurality of logical channels, respective bits to represent data of the logical channel, wherein a total number of bits of the second set of bytes which represent data of the plurality of logical channels is equal to the total bit capacity of the plurality of logical channels.
